(19) United States
(12) Patent Application Publication
(10) Pub. No.: US 2023/0103930 A1
(43) Pub. Date: Apr. 6, 2023

(54) IMPACT SHIELD STRUCTURES

(71) Applicant: BAE SYSTEMS plc, London (GB)

(72) Inventors: Daniel Benjamin Black, Chelmsford Essex (GB); Kinjal Ketanbhai Dave, Chelmsford Essex (GB)

(73) Assignee: BAE SYSTEMS plc, London (GB)

(21) Appl. No.: 17/907,129

(22) PCT Filed: Mar. 11, 2021
(86) PCT No.: PCT/GB2021/050619

§ 371 Date: Sep. 23, 2022

(30) Foreign Application Priority Data
Mar. 27, 2020 (GB) 2004468.1

(51) Int. Cl. B64G 1/56; B64G 1/54

(52) U.S. Cl. CPC B64G 1/56; B64G 1/54

(57) ABSTRACT

In some examples, an impact shield structure for use on a lower earth orbit spacecraft comprises a capture layer to absorb debris incident thereon.

### TECHNICAL FIELD

Aspects relate, in general, to impact shielding techniques particularly, although not exclusively to shielding structures for protecting spacecraft components from damaging impact.

### BACKGROUND

Space debris, such as human made debris in the form of, e.g., stranded and faulty nuts and bolts, used upper stage rocket bodies etc. can vary in sizes. Such debris can collide with satellites and other space architecture resulting in structural and systematic damage. Due to fragmentation and collisions with other debris, there is now a large amount of debris in a range of sizes from about I mm-I cm.

This can be problematic, since many existing solutions for mitigating the effects of debris incident on spacecraft do not address this size range. In particular, in lower-Earth orbits (LEO), (that are defined as orbits nearest to Earth in which spacecraft can have an orbital altitude of up to around 2,000 km) there is large amount of debris in this size range representing a significant risk to spacecraft that are either orbiting in that region of space or passing through.

### SUMMARY

According to an example, there is provided an impact shield structure for use on a lower earth orbit spacecraft, comprising a capture layer to absorb debris incident thereon. The capture layer can be provided between first and second encapsulating layers disposed on either side thereof. For example, the encapsulating layers can be used to maintain the structural integrity of the capture layer. In an example, the first encapsulating layer can comprise a layer of graphene foam, a layer of ceramic metallic material, and/or an outer skin of the spacecraft. The second encapsulating layer can comprise a layer of graphene foam. The capture layer, and the first and second encapsulating layers can form a monolithic layer. That is, in an example, these layers can be formed from the same material.

In an example, the capture layer can comprise a powdered ceramic material. For example, the capture layer can consist of ceramic particles. One or more additives may be used that may be geared to improve the ability to fabricate a layer formed using the powder. An outermost entry layer may be provided that can comprise, for example, a self-healing fabric or self-healing material comprising microcapsules of material that can rupture to release the material and seal any local damage such as cracks and so on.

An impact shield structure according to an example can further comprise an electromagnetic, EM, shield layer to absorb radiofrequency, RF, energy incident on the structure. The EM shield layer can comprise a metallic mesh, metallic sheet, or multiple metallic wires, and may be provided within or as part of the capture layer, and/or within or as part of the first encapsulating layer. The EM shield layer can comprise multiple apertures with a dimension of around 0.I times a selected target RF wavelength. For example, the EM shield layer can mitigate against uplink jamming in which an RF signal of the same frequency as a targeted uplink signal is transmitted to the platform in question with the aim to limit a platform transponder from differentiating between the jamming signal and an actual signal originating from a ground station or user terminal. In an example, a selected target RF frequency can be in the GHz region of the EM spectrum. In an example, this corresponds to an aperture dimension of around between 0.I-I mm. In an example, an aperture dimension may be in the region of between 0.I-I0 mm.

In an example, the capture layer can be so configured as to absorb debris with a diameter of around I mm to I cm. This broadly corresponds to the debris that may be found in the LEO. The structure can have an overall thickness of around I cm to I0 cm. For example, the capture layer may be between I-I0 cm. In another example the capture layer may comprise somewhere between I0-90% of the thickness of the structure, with other layers comprising the remaining I0-90%. Various permutations of layers are possible, as will be described in more detail below. The structure is so configured as to absorb debris directly incident on the structure, and debris that ricochets from an encapsulating layer.

### BRIEF DESCRIPTION OF THE FIGURES

Embodiments will now be described, by way of example only, with reference to the accompanying drawings, in which FIGS. I to 5 are schematic representations of a shield structure according to various examples.

### DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

Spacecraft, which may be characterised as any vehicle or machine designed to fly or orbit in outer space (such as artificial satellites for example), can suffer damage as a result of impacts from debris. Debris in the sense of the present description can include human-made debris comprising, for example, defunct objects or parts thereof that are no longer of use, as well as debris formed from non-human-made objects, such as fragments of micrometeoroids

Shields suitable for protecting spacecraft from impact with ballistic projectiles and other types of impacting particles have been proposed. For example, some shields have been proposed that comprise layers of fabric composed of low density and high density material that are bonded together to provide micrometeorite protection, radiation protection, and so on. However, such shielding is incapable of providing protection against both high and low velocity particle collisions. There is also no technology at present to address the problem posed by both hard and soft debris.

Other shield designs comprise ceramic outer layers and, e.g., nylon felt layers backed by a metallic layer. The felt layers are stitched together into a cloth-like configuration. However, such shields provide protection only against relatively low velocity particles, and, in common with other shields can cause impacting debris to fragment and ricochet upon collision, thereby compounding to the problem in the size range mentioned above.

Other shielding technologies, such as Whipple shields for example, have been used. Such devices comprise an outer bumper spaced from a spacecraft wall. The bumper causes an impacting projectile to fragment upon impact and disperse, thereby dividing the original energy of the projectile over the multiple fragments that result from the impact with the bumper. The idea is of reducing the impact by letting the bumper layer shear (behaving like a body armour). As each of these fragments has a lower energy, less damage is likely, although there are still ricochets and damage to the bumper that somewhat reduces its subsequent ability to deal with further impacts.

Given the prevalence of micrometeoroid and orbital debris (MMOD) in the size ranges mentioned in low earth orbit, there is a substantial probability of MMOD collision or interference with a range of operating assets as well as a serious threat to in-space personnel. As noted, many active debris solutions do not address the size range of I mm to I cm, even though there are more than I28 million pieces of such debris in LEO (Lower Earth Orbit).

According to an example, there is provided an impact shield structure for use on spacecraft, such as spacecraft in lower earth orbit, comprising a capture layer to absorb debris incident thereon. That is, instead of a shielding that is geared to prevent damage by armoring the underlying craft causing ricochets and fragmentation, the present shield structure absorbs incident projectiles. Damage to the underlying craft is thus minimised and an increase in ballistic projectiles caused because of ricochets and fragmentation is prevented.

For example, debris, such as in the form of a ballistic projectiles, incident on a shielding structure according to an example will not generate multiple fragmented portions that may ricochet from the structure. Rather, the debris is ‘absorbed” by the shielding structure and becomes embedded therein.

According to an example, a shielding structure can comprise of a coating that acts as a ballistic armour by absorbing the impact of a projectile to a point where it is captured. The projectile embeds itself into the structure without inducing any damage to the spacecraft and/or production of more debris or shattering the armour. In an example, target debris in a size range of around I mm to I cm will typically have speeds of less than I0 km/s and a weight range of between around I-I0 gms. This includes soft and hard debris. Accordingly, the kinetic energy of debris in such a range will be around the magnitude of up to around 500 kJ. In an example, a thickness of a shielding structure can be between I cm to I0 cm, such as between 2 to 5 cm for example, which will be sufficient to absorb debris in the size and energy ranges indicated. However, the thickness of an overall shielding structure according to an example can be tailored to the application at hand and the above examples are not intended to be limiting.

According to an example, a shielding structure can comprise a capture layer that comprises one or more of a number of different materials. Additional layers can be provided to augment or amplify the function of the shielding structure. For example, one or more encapsulating layers may be provided. An encapsulating layer can be provided adjacent to the capture layer, and one such encapsulating layer may be provided on either side of the capture layer, thereby forming a sandwich structure of: encapsulating material-capture layer material-encapsulating material. Other layers may be provided in addition to or instead of some or all of these layers, such as an entry layer and an electromagnetic (EM) shield layer, which are described in more detail below.

In an example, if present, an entry layer can comprise a self-healing material such as a material that has a low tendency for discharge, for example a metallic self-sealable material. This can prevent material escaping via discharge, which may happen due to high levels of energy transfers in back layers for example.

FIG. I is a schematic representation of a shield structure according to an example. The shield structure of FIG. I is depicted disposed on a surface of a platform I0I, such as a spacecraft for example, for ease of visualisation and description. The shield structure comprises a capture layer I00. The capture layer has an exposed surface I03, upon which debris may be incident, and a surface I05 that is adhered or fixed to a surface of the platform I0I. The width, x, of the capture layer I00 may be in the region of I-I0 cm.

The capture layer I00 may comprise a monolithic layer of material or combination of materials. For example, the capture layer may comprise:
a monolithic layer of Graphene Foam (or foamed graphene);
Graphene foam impregnated with ceramic powder—this can provide a semi-rigid structure to further dissipate energy from impacts;
Graphene foam impregnated with metallic dust (dispersed metallic particles can perform as an EM shield as they will block radio waves, which can be used for the purposes of upstream jamming prevention for example);
Sandwich of graphene foam with composite fabric containing pockets of non-Newtonian fluid (i.e. fluids that tend to behave like solids when subjected to stress or force);
Sandwich of graphene foam and ceramic powder encased in a Nextel fibre case (the powder can be used to further dissipate energy as it can be transferred into the ceramic powder via friction);
Sandwich of metallic foam impregnated with graphene.

The above is not intended to be an exhaustive listing of the materials and combinations that may be used, and any combination or subset of the above may be used. Accordingly, the capture layer I00 can be customised according to the end requirements.

In an example, a shield structure can comprise a number of cells, with each cell comprising one of the combinations noted above, for example. Accordingly, the number of cells and the cell configuration can be selected as desired. A platform may benefit from having cells comprising differing structures in different regions.

For example, a cell that comprises a first structural configuration (e.g. with a capture layer composed of a first material) may be placed in one region of the platform to protect, e.g., a vulnerable asset, whilst a cell that comprises a second structural configuration (e.g. a capture layer composed of a second material) may be placed in another region of the platform to protect a different asset, which may be more (or less) vulnerable, and so on.

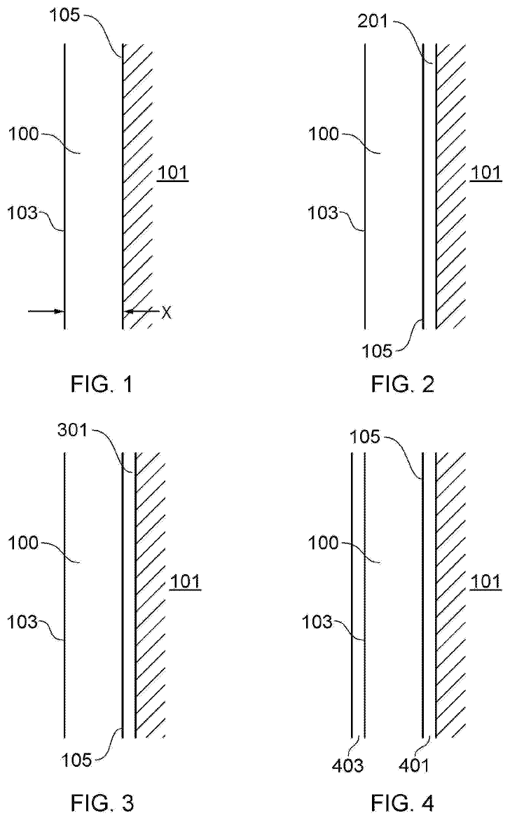

FIG. 2 is a schematic representation of a shield structure according to an example. In the example of FIG. 2 the shield structure further comprises an EM shield layer 20I. In the example of FIG. 2, the EM shield layer 20I comprises a thin sheet of metallic mesh. Such mesh can have a cross section of the size of around I/I0^{th} of the wavelength that is desired to be blocked and may be around I mm thick. That is, the mesh can define apertures that are dimensioned to be around I/I0^{th} of the wavelength of EM radiation that is desired to be blocked. In some examples, a metallic sheet, or multiple metallic wires may be used, either in isolation, or in combination with each other and/or a metallic mesh. The EM shield layer 20I will absorb RF waves, protecting the platform I0I from upstream jamming.

In the example of FIG. 2, the EM shield layer 20I is provided on the surface I05 of the capture layer I00. In other examples, the EM shield layer 20I may be provided within the capture layer I00, at the surface I03, or some combination of these positions. For example, part of an EM shield layer 20I may be provided in a different position within or on the capture layer I00 in relation to another part of the EM shield layer 20I.

FIG. 3 is a schematic representation of a shield structure according to an example. In the example of FIG. 3 the shield structure further comprises a final protection layer 30I. In the example of FIG. 3, the final protection layer 30I comprises a robust layer provided on the surface I05 of the capture layer I00. In an example, the final protection layer 30I can comprise a layer of Aluminium Oxynitride, or other metallic ceramic. The final protection layer 30I can absorb mechanical impacts and thermal shock. Furthermore, debris incident on the shield structure with energy sufficient to traverse the capture layer I00 and any other layers that may be in use, will rebound from the final protection layer 30I without damaging the platform I0I. Furthermore, the rebounding debris may then become embedded into the capture layer I00 despite the fact that it has initially passed through as it will lose energy over the course of its passage through the shield structure and because of the rebound. That is, in an example, if debris or a micrometeoroid for example traverses all layers of the shield structure before the final protection layer 30I such that it has not disintegrated, fragmented or been captured on its passage through to the final protection layer 30I, it can be captured in the capture layer I00 as a result of its deceleration caused by deflection from the final protection layer 30I.

FIG. 4 is a schematic representation of a shield structure according to an example. In the example of FIG. 4, the capture layer I00 is provided between first 40I and second 403 encapsulating layers. The encapsulating layers are disposed on either side of the capture layer I00. The first encapsulating layer 40I can comprise, for example, a layer of graphene foam, a layer of ceramic metallic material, and/or an outer skin of the platform I0I. The second encapsulating layer 403 can comprise a layer of graphene foam. Although first and second encapsulating layers are depicted in the example of FIG. 4, one or other of these layers may be omitted in a shield structure according to an example. Furthermore, the capture layer I00 and the first 40I and second 403 encapsulating layers may be in the form a monolithic layer (that is, in which all three layers are made from the same material) In an example, an EM shield layer 20I can be provided within or as part of an encapsulating layer, preferably the first encapsulating layer 40I whereby to minimise damage to the EM shield.

According to an example, the capture layer I00 can comprise a powdered ceramic or ceramic powder material. For example, the capture layer I00 may comprise ceramic particles, such as Alumina, Boron nitride, Magnesia, Aluminium nitride, Zirconia fibre powder, Zirconia powder, Boride/Boron/Carbides/Nitrides and so on, and optionally a additive or additives, which may be transient in nature, such as a binding agent (e.g. PVA, PEG etc.) to hold the powder together after compaction and optionally a release agent to enable a compacted component to be removed from a compaction die. One or more encapsulating layers can be provided in order to maintain the structural integrity of the powdered ceramic.

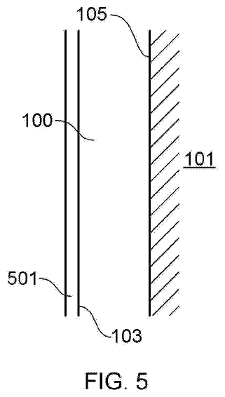

FIG. 5 is a schematic representation of a shield structure according to an example. In the example of FIG. 5, an outermost entry layer 50I is provided. The entry layer 50I can be provided on the surface I03 of capture layer I00 and may comprise a self-healing fabric or material. Such a layer can be provided in combination with any of the other layers described above. The entry layer can be provided as a mechanism to maintain the structural integrity of, for example, a powdered ceramic material used as a capture layer.

The various layers described above with reference to FIGS. I to 5 may be combined in any desired manner to form a shield structure, and, in an example, such a structure can have an overall thickness of around I cm to I0 cm. A shield structure according to an example therefore provides a solution for active debris removal for debris in the size range I mm-I cm (diameter), which is a range within which there does not currently exist a solution. It also provides a structure that is suitable for us in protecting large areas of a platform, rather than smaller specific parts. Furthermore, due to the flexibility of materials used, the size and shape of the shield structure can be bespoke with the size and shape being tailored according to its function. For example, for optical sensors and sensitive parts, selected parts of a shield structure can be excluded or replaced with other materials. A shield structure according to an example can capture or absorb debris instead of initial deflection or disintegration on impact of debris. This includes capturing debris that may rebound from a final layer, such as the final protection layer, which may in fact comprise the skin of the platform to which the structure is mounted or formed as part of.

Since the threat of EM jamming becomes more prominent, enabling an EM shield layer to be provided as part of the shield structure is advantageous, and an EM shield layer can be provided as part of or within an existing layer, or provided as a standalone layer in its own right.

The present inventions can be embodied in other specific apparatus and/or methods. The described embodiments are to be considered in all respects as illustrative and not restrictive. In particular, the scope of the invention is indicated by the appended claims rather than by the description and figures herein. All changes that come within the meaning and range of equivalency of the claims are to be embraced within their scope.

1. An impact shield structure for use on a lower earth orbit spacecraft, the impact shield structure comprising:
a capture layer to absorb debris incident thereon.

2. The impact shield structure as claimed in claim 1, wherein the capture layer is provided between first and second encapsulating layers on either side thereof.

3. The impact shield structure as claimed in claim 2, wherein the first encapsulating layer comprises a layer of graphene foam, a layer of ceramic metallic material, and/or an outer skin of the spacecraft.

4. The impact shield structure as claimed in claim 2, wherein the second encapsulating layer comprises a layer of graphene foam.

5. The impact shield structure as claimed in claim 2, wherein the capture layer and first and second encapsulating layers form a monolithic layer.

6. The impact shield structure as claimed in claim 1, wherein the capture layer comprises a powdered ceramic material.

7. The impact shield structure as claimed in claim 1, further comprising an outermost entry layer comprising a self-healing fabric.

8. The impact shield structure as claimed in claim 1, further comprising an electromagnetic (EM) shield layer to absorb radio frequency (RF) energy incident on the structure.

9. The impact shield structure as claimed in claim 8, wherein the EM shield layer comprises a metallic mesh, metallic sheet, or multiple metallic wires.

10. The impact shield structure as claimed in claim 8, wherein the EM shield layer is provided within or as part of the capture layer.

11. The impact shield structure as claimed in claim 2, wherein an electromagnetic (EM) shield layer, to absorb radio frequency (RF) energy incident on the structure, is provided within or as part of the first encapsulating layer.

12. The impact shield structure as claimed in claim 8, wherein the EM shield layer comprises multiple apertures with a dimension of around 0.1 times a selected target RF wavelength.

13. The impact shield structure as claimed in claim 1, wherein the capture layer is so configured as to absorb debris with a diameter of around 1 mm to 1 cm.

14. The impact shield structure as claimed in claim 1, wherein the structure has an overall thickness of around 1 cm to 10 cm.

15. The impact shield structure as claimed in claim 1, wherein the structure is so configured as to absorb debris directly incident on the structure, and debris that ricochets from an encapsulating layer.

16. An impact shield structure for use on a lower earth orbit spacecraft, the impact shield structure comprising:
a capture layer to absorb debris incident thereon, the capture layer comprising a powdered ceramic material;
a first encapsulating layer on a first side of the capture layer, the first encapsulating layer comprising a layer of graphene foam, a layer of ceramic metallic material, and/or an outer skin of the spacecraft; and
a second encapsulating layer on a second side of the capture layer, the second encapsulating layer comprising a layer of graphene foam.

17. The impact shield structure as claimed in claim 16, wherein the capture layer and first and second encapsulating layers form a monolithic layer having an overall thickness of around 1 cm to 10 cm.

18. An impact shield structure for use on a lower earth orbit spacecraft, the impact shield structure comprising:
an electromagnetic (EM) shield layer to absorb radio frequency (RF) energy incident on the structure, the EM shield layer comprising a metallic mesh, metallic sheet configured with apertures, or multiple metallic wires;
a capture layer to absorb debris incident thereon, the capture layer comprising a powdered ceramic material; and
an outermost entry layer comprising a self-healing fabric;
wherein the capture layer is between the EM shield layer and the outermost entry layer.

19. The impact shield structure as claimed in claim 19, comprising:
a first encapsulating layer on a first side of the capture layer, the first encapsulating layer comprising a layer of graphene foam, a layer of ceramic metallic material, and/or an outer skin of the spacecraft; and/or
a second encapsulating layer on a second side of the capture layer, the second encapsulating layer comprising a layer of graphene foam.

20. The impact shield structure as claimed in claim 18, wherein shield structure can comprises a number of cells, including a first cell and a second cell, the first cell comprising a first structural configuration, and the second cell comprising a second structural configuration, the first and second structural configurations being different from another.
